(19) United States
(12) Patent Application Publication
(10) Pub. No.: US 2017/0227209 A1
(43) Pub. Date: Aug. 10, 2017

(54) Low-Profile IP65 Rated Easy Access LED Light Fixture Housing

(71) Applicants: Dan SLABEK, Chicago, IL (US); John PEÑA, Chicago, IL (US); Alonzo IBARRA, Chicago, IL (US)

(72) Inventors: Dan SLABEK, Chicago, IL (US); John PEÑA, Chicago, IL (US); Alonzo IBARRA, Chicago, IL (US)

(73) Assignee: 555 International, Inc., Chicago, IL (US)

(21) Appl. No.: 15/019,170

(22) Filed: Feb. 9, 2016

(51) Int. Cl. F21V 31/00; F21V 17/12; F21K 99/00; F21V 15/01

(52) U.S. Cl. CPC F21V 31/005; F21V 15/01; F21V 17/12; F21K 9/175; F21Y 2101/02

(57) ABSTRACT

A housing for a lighting fixture is provided such that the fixture has IP65 or better impermeability. The housing includes a base pivotally connected to a lid, the lid including a light permeable diffuser, a pliable gasket between the lid and base, and fastening means including a fastener on the lid and a flange on the base. The flange is provided with a linear cam portion diametrically opposed to the pivot, and an opening defined in the flange, such that when the lid is pivoted to proximity with the base and the fastener is tightened, the distal end of the fastener will contact the linear cam pulling the lid into sealed relation with the base. The fastener being tightenable such that its distal end enters the opening in the flange, thereby locking the lid onto the gasket and base to form an IP65 impermeable relationship.

### FIELD OF THE INVENTION

The present invention concerns housings for lighting fixtures. More particularly the present invention concerns IP65 vapor tight low profile lighting fixtures allowing outdoor/harsh environment placement of costly modern lighting fixtures with easier access to interior of the housing while maintaining impermeability.

### BACKGROUND OF THE INVENTION

Electronic fixtures are given a rating of Ingress Protection, or IP, rating. The IP Code, International Protection Marking, IEC standard 60529, sometimes interpreted as Ingress Protection Marking, classifies and rates the degree of protection provided against intrusion (body parts such as hands and fingers), dust, accidental contact, and water by mechanical casings and electrical enclosures. This rating system is created and published by the International Electrotechnical Commission (IEC).

The standard aims to provide users more detailed information than vague marketing terms such as “waterproof”. The digits (characteristic numerals) indicate conformity with various conditions and can be found in tables created by the IEC. Many government agencies, municipalities, corporations and others look to a rating of IP65 for outdoor lighting. As noted above, the IP rating comprises a two number system, the first being for protection against intrusion by solid objects, and the second by liquids. The numbers progress from 0, meaning no protection to 6 for solids and 8 for liquids indicating no ingress or no ingress for a specified time period of exposure. A larger number encompasses all of the protection of each lower number as well. A rating of IP65 then, indicates a device that will withstand intrusion by all solid objects (as 6 is the highest rating for solids) and for all intrusion of water of vapor up to low-pressure jets of water from all directions. Higher protection against water is possible and rated higher, to include those items that are impermeable to strong jets of water and long and deep immersion in liquids. The IP65 standard has been found to be the sufficient and top standard needed for lighting fixtures exposed to atmospheric conditions in such places as transit stations, covered passages and others.

The advent of modern methods of lighting, including light emitting diodes (LEDs), mercury vapor, halogen, fluorescents and others have led to brightening up public plazas, transportation stations and other outdoor areas. Typically, such places are vulnerable to weather conditions that are inconsistent with electrical fixture longevity. Lighting fixtures tend to fail in the presence of moisture, either from atmospheric conditions or other moisture conditions.

Prior art lights have provided vapor tight casings that are typically made in such a way that the means and method of making such fixtures vapor tight increase the size of the fixture and require a person to exert considerable force to make the fixture water and vapor tight. Such fixtures have typically been made in such a way that the means to make the fixture impermeable is created at a point diametrically away from the fixture light so as not to interfere with the light and so as to provide the most force in a direction opposite to the typical direction of ingress of solids and liquids. As the fixtures are often placed in a ceiling, the means of providing ingress protection is typically located at the top of the fixture in such orientation as the typical direction of water and solid attack is from below the fixture. As the means to open the fixture for access, then, is at the top of the fixture, the fixture must typically be removed from the ceiling to provide any maintenance, including the changing out of light elements. While with the advent of LED lighting, such maintenance can be delayed; eventually the fixture must be removed in the event of failure or for maintenance.

It is therefore an object of the present invention to provide a means for providing lighting with a rating of at least IP65 for lighting fixtures that are lower in profile, smaller in size, require less force to create the impermeability and are easier and less expensive to manufacture and install. Further, the present invention provides IP65 rated ingress protection while providing easy access to the interior of the fixture without removal of the fixture from its sites, easy access to the lighting element and other elements of the fixture all with the ability to restore the IP65 rating after maintenance or repair without removal.

Other objects and advantages of the present invention will become apparent as the description proceeds.

### SUMMARY OF THE INVENTION

In accordance with the present invention, a light fixture housing having IP65 or better impermeability protection when closed, is provided. The housing comprises a base, in the shape of a box, having a bottom and sides, and having space within the box for a light fixture to be placed therein. The base is pivotally attached, by pivoting means, at one side to a lid having a lens thereon, the base includes means to fasten the lid and box together on a side opposite to the pivoting means. The fastening means is at least a fastener and a linear cam.

When it is desired to seal the fixture housing, the base and lid are brought close together by pivoting one towards the other and then fastening the lid to the base. Sealability, to the IP65 impermeability standard is achieved by tightening of the fastener against the linear cam such that the force of the fastener against the plane pivots the lid tightly against the base.

In a preferred embodiment of the present invention, the fastener is a screw and tightening the screw pushes the end of the fastener against the linear cam, the fastener being attached to the lid and the linear cam being fixed to the base, such that the lid is pulled, pivotally, towards the base. In addition, the linear cam is joined to a flange having an opening in which the distal end of the fastener is locked when fully tightened. The preferred embodiment includes a pliable gasket, fitted between the lid and base, to perfect a seal when the base and lid are fastenably joined together. The present invention includes a flange attached to the lid and the fastening means includes a nut fixed to the lid, at the flange, for receiving the fastener therein.

So as to cause the tightening of the fastener to pull the lid down onto the base, the surface of linear cam, which the distal end of the fastener presses against as it is tightened, is inclined between 20° and 70° degrees; and preferably 45°. In a preferred embodiment of the invention, the lighting fixture is an LED light fixture. It will be understood that the preferred means to pivot the lid to the housing is a hinge.

The preferred embodiment of the invention is then described as a light fixture housing having IP65 or better impermeability protection when closed, having a base, comprising a box, having a bottom and sides, and having space for a light fixture to be placed therein, the base being pivotally attached, by a hinge, at one side to a lid having a diffuser thereon, the base having fastening means on a side opposite to the hinge, the fastening means comprising at least a screw, a nut (preferably attached to the lid so as to allow the user to screw in the fastening means single handedly) and a linear cam. The base and lid being fastenably closed together such that the screwing the fastener into the lid pushes the distal end of the screw against the linear cam, inclined at 45°, causing the lid to pivot tightly against the base to create the IP65 impermeability. The linear cam is joined to a flange having an opening in which the distal end of the screw parks or is locked when the screw is fully tightened into the lid. In addition, a pliable gasket is included between the lid and base to perfect the seal when the base and lid are fastenably joined together.

A more detailed explanation of the invention is provided in the following description and claims and is illustrated in the accompanying drawings.

### BRIEF DESCRIPTION OF THE DRAWINGS

FIG. 1 is a perspective view of a prior art IP65 lighting fixture.

FIG. 2 is a perspective view of a fixture of the present invention.

FIG. 3 is a perspective cross-sectional view of a segment of the case of the fixture of FIG. 2.

FIG. 4 is a cross-section view of the casing of FIG. 3.

FIGS. 5A-5C are elevational views of a second embodiment of the fixture of FIG. 2 in various stages of action (closed, unlocked and opened).

FIG. 6 is a perspective view of the fixture of FIG. 2 in an open position.

FIG. 7 is an exploded perspective view of the fixture of FIG. 6.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

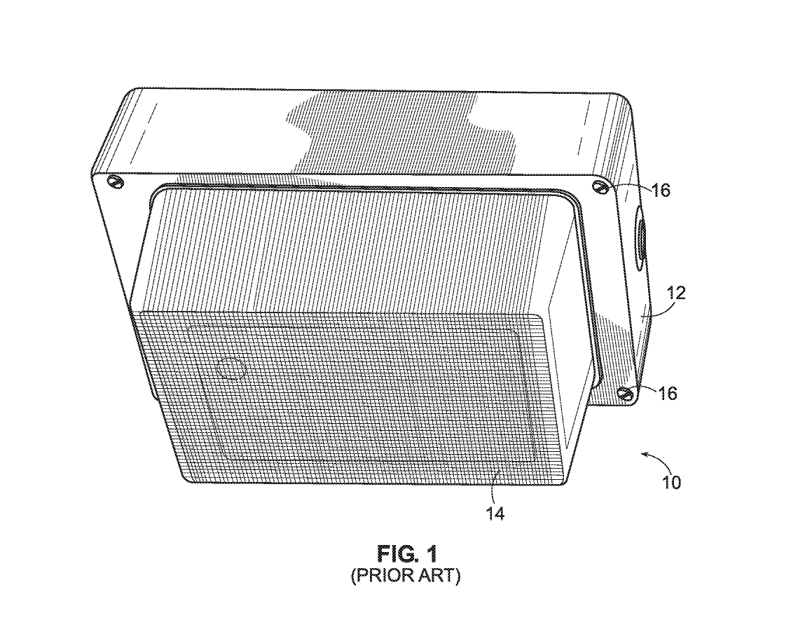

Referring now to the drawings, FIG. 1 shows a typical example of an IP65 lighting fixture 10 of the prior art. The fixture 10 comprises an exterior base 12 and a light cover or diffuser 14 that together are of the type that are frequently attached to a ceiling. Fixtures such as the one shown in FIG. 1 are typically attached to the ceiling using conventional means wherein an interior structural component is fastened to structural elements of the ceiling at or about the ingress of electrical service into the ceiling. From that interior structural component the bulk of the lighting fixture is attached, as an example, the exterior base 12 of the fixture 10 of FIG. 1 is shown having fasteners 16 which attach the exterior base to the structural element. In the case of lamps having IP65 or similar capabilities it will be understood that a seal to prevent ingress of material (whether liquid or solid) into the lamp must be created. Typically this is done by pulling elements, such as diffuser 14 against exterior base 12 so as to minimize the space therebetween—to reach the IP65 standard a gasket, made of pliable materials such as rubber or silicone, is often used to better perfect the seal. Viewing the lamp of FIG. 1, from the exterior, it is not clear how diffuser 14 is attached to exterior base 12; however in most such fixtures 10 there are means, such as screws, bolts or latch assemblies, to pull diffuser 14 onto base 12 from above (as the fixture is situated in FIG. 1) and from the inside of the fixture. As such, the base and diffuser are of necessity made to a greater overall depth (or height) to accommodate the means to pull the diffuser to the base. In addition, to seal the elements together in a direct mariner as these prior art fixtures are assembled, requires considerable force on each fastener to pull the elements into a properly sealed relationship. It will be understood that when such fixtures require servicing, such as the replacement of the lighting element or repair from damage including vandalism, the fixture would characteristically have to be removed from the ceiling so as to repair it and then once again achieve the IP65 level of sealing prior to then reattaching the fixture to the ceiling.

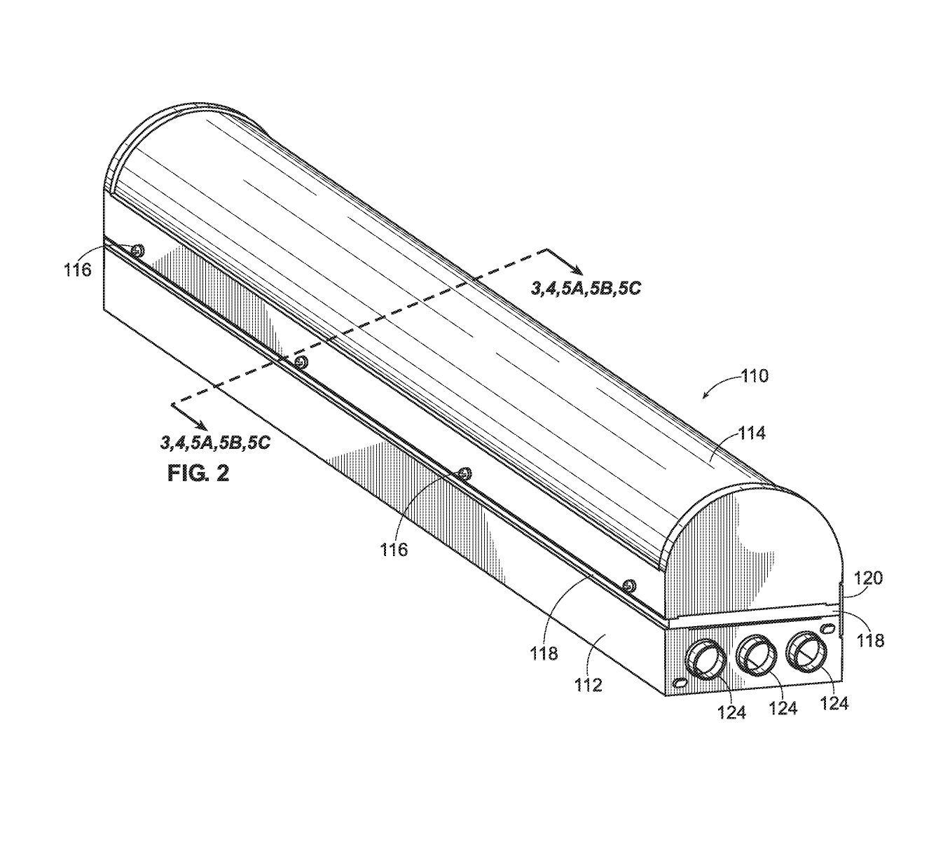

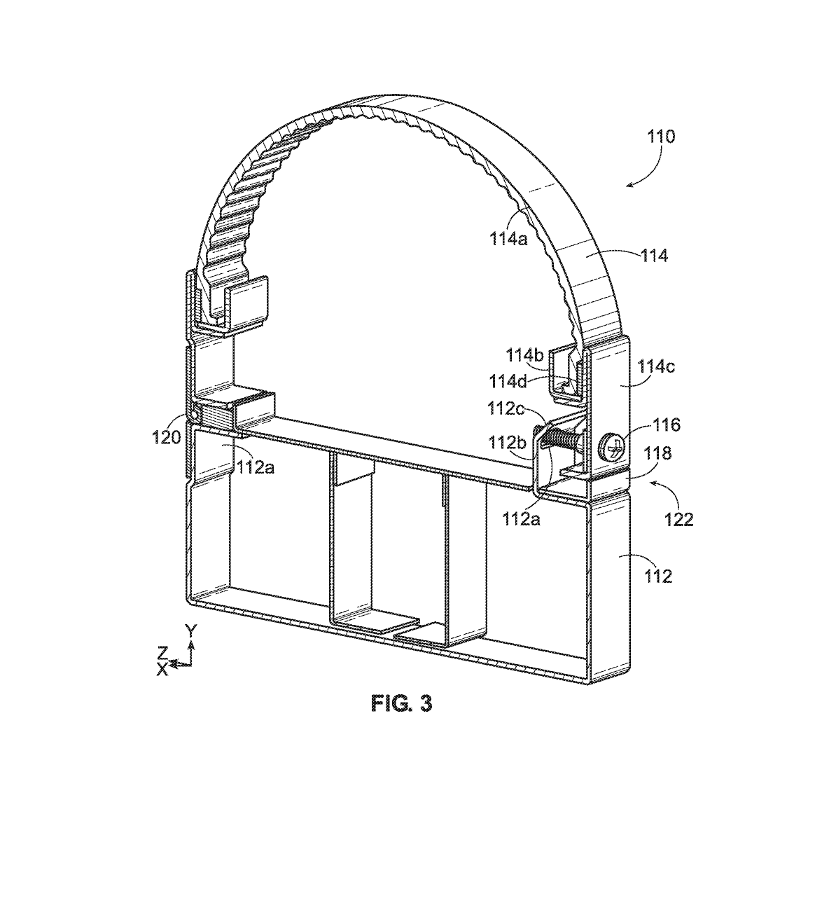

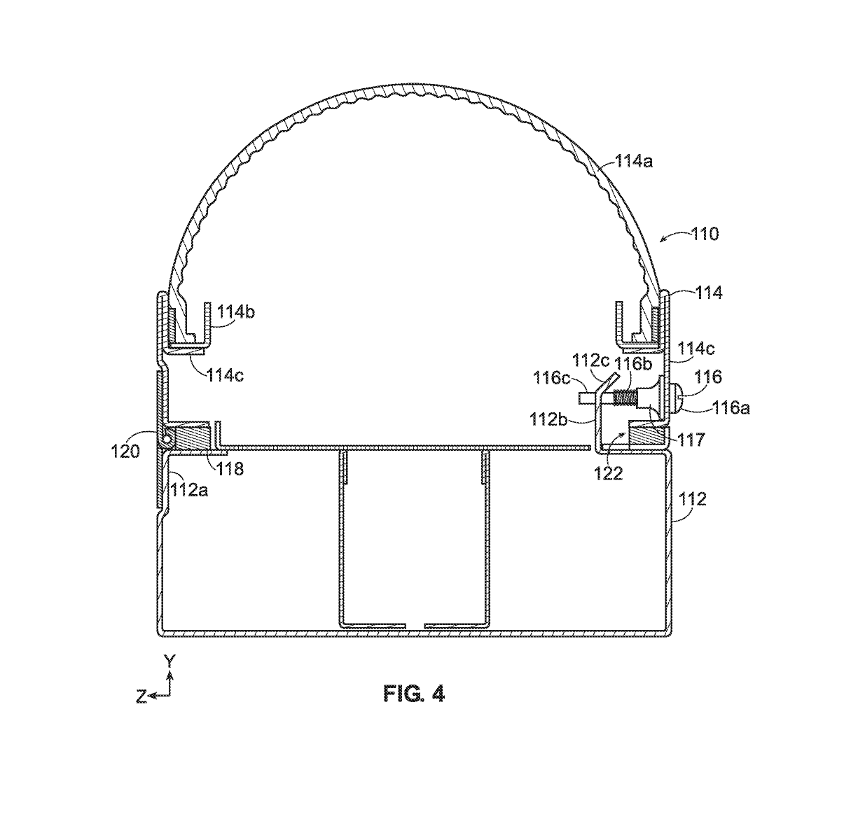

FIG. 2 shows a perspective view of the exterior housing of the lighting fixture 110 of the present invention. Fixture 110 comprises an exterior base 112 and a light cover or diffuser 114 and fasteners 116. In contrast to the fasteners 16, used to attach a sealed cover to a base in the prior art device of FIG. 1, fasteners 116, in the present invention, are used to seal the cover and base to the IP65 standard as will be explained in greater detail below. Fixture 110 further includes a gasket 118 and a hinge 120 (as more clearly shown in FIG. 3). Referring to FIGS. 3 and 4, a cross-section element of the fixture 110 is shown in a closed-sealed position. It will be seen that between base 112 and diffuser 114 a seal 118, made from rubber, silicon or other pliable materials having the properties of being able to compress to fill all space 122 between these elements, is seated to help create the IP65 impermeability.

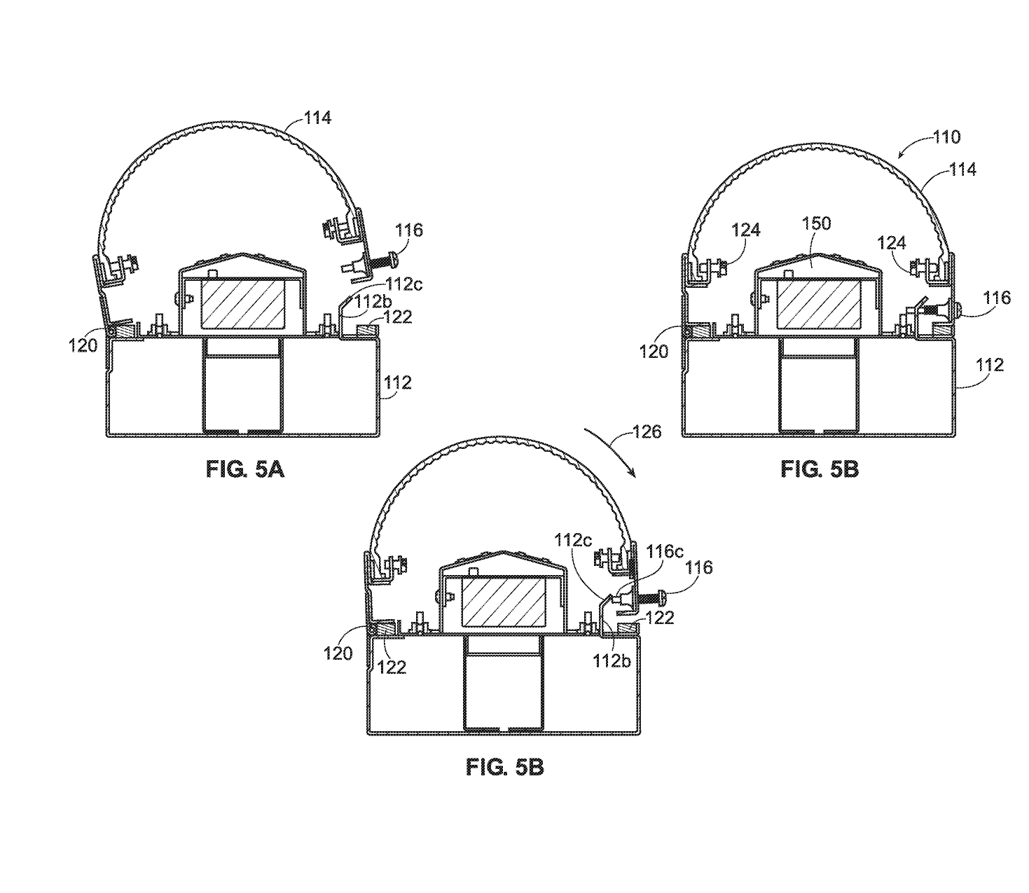

Diffuser 114 in a preferred embodiment, is created using a lens 114a, which as shown is a typical corrugated Fresnel type translucent element that tends to provide clean white light, seated between a bracket 114b and a bracket 114c, with a thin sealing gasket 114d therebetween to form this element of fixture 110. Base 112 comprises a box element made of metal, such as aluminum or steel, or plastic or other structurally stable material that can be formed to the shape necessary for its function. It will be seen that in the preferred embodiment base 112 comprises a hinge attachment flange 112a on one side and an extended flange 112b, comprising an opening 112o therein, flange 112b having an extended inclined element 112c, which will be described in greater detail below. Referring again to FIG. 2, it will be seen that base 112 can include any number of ingresses 124 for attachment of cables or other means to bring electricity and control means to fixture 110. Other elements of the interior of base 112 are shown, but can be made in differing forms to accommodate, for connection means and structural support, different lamp units 150 (FIG. 5 et seq.) to be housed therein.

Referring to FIGS. 3 and 4 in conjunction with FIGS. 5, it will be seen that diffuser 114 is pivotally attached to base 112. It will be seen that FIG. 5 shows an embodiment of the present invention in an open (5A), latched (5B) and sealed (5C) configuration. The most significant difference between the lamps of FIG. 4 and FIG. 5 is the addition of fastening means 124 to flange 114b that, in action, helps to hold lens 114a to diffuser 114. In the preferred embodiment of the present invention, the pivot means 120 is a simple piano style hinge that runs the length of fixture 110; persons having ordinary skill in the art will understand that any method of pivot can be substituted therewith to achieve the necessary pivoting function of the present invention. As will be described in greater detail herein, the pivot and the use of the linear cam of element 112c of base 112 in conjunction with fastener 116 are essential to the sealing action of the present invention.

Fastener 116, in a preferred embodiment, is a screw (preferably having a Philips head 116a) with an extended threaded section 116b and a non-threaded cylindrical end 116c. A low profile nut 117 is provided, and in a preferred embodiment, is fixed to flange 114c so as to be self-supporting during use to allow fastener 116 to be threaded into fixture 110 more easily; and using only one hand.

Referring now to FIG. 5A, fixture 110 is shown in an open position for inspection, maintenance, repair or other reasons. Fastener 116 is shown in a configuration wherein it has been unscrewed such that it is partially out of nut 117 and the pivoting action of the diffuser 114 relative to the base 112 causes the end 116c of fastener 116 to completely clear the inclined element 112c of flange 112b. In the operation to seal diffuser 114 to base 112, the user would pivot the diffuser 114 in the direction of arrow 126 (FIG. 5B) and thread the fastener 116 in the diffuser 114 into base 112, such that fastener end 116c touches inclined element 112c of flange 112b. It will be understood, then, that the continued screwing-in of fastener 116 will cause the force used to screw the fastener 116 in to be exerted onto the linear cam 112c, causing diffuser 114 to continue pivoting down (in accordance with the orientation of FIG. 5) onto gasket 122. The continued screwing will then cause fastener end 116c to seal diffuser 114 to base 112; fastener end 116c eventually being tightened such that it enters and is threaded into opening 112o of flange 112b, locking the fixture into a sealed IP65 impermeability. It will be seen in FIG. 2, that in a preferred embodiment the above described fastening procedure is duplicated several times along the length of fixture 110 so as to spread the closing force along the length of and more completely seal the entire length of the fixture.

When it is desired to open fixture 110, for whatever reason, fastener 116 need only be unscrewed to cause the gentle release of sealability as the fastener(s) 116 are loosened as the fastener end 116c withdraws from opening 112o and slides along the linear cam 112c until the diffuser 114 pivots away from the base 112.

It will be understood that while a Philips-type head is described, a special fastener head configuration, having a proprietary configuration and using a specific tool can be used so as to lock the fixture closed and provide a deterrent from unauthorized opening of the fixture. Such proprietary screw heads and tools are well known to persons having ordinary skill in the art. The use thereof providing additional security to the fixture against unwanted ingress.

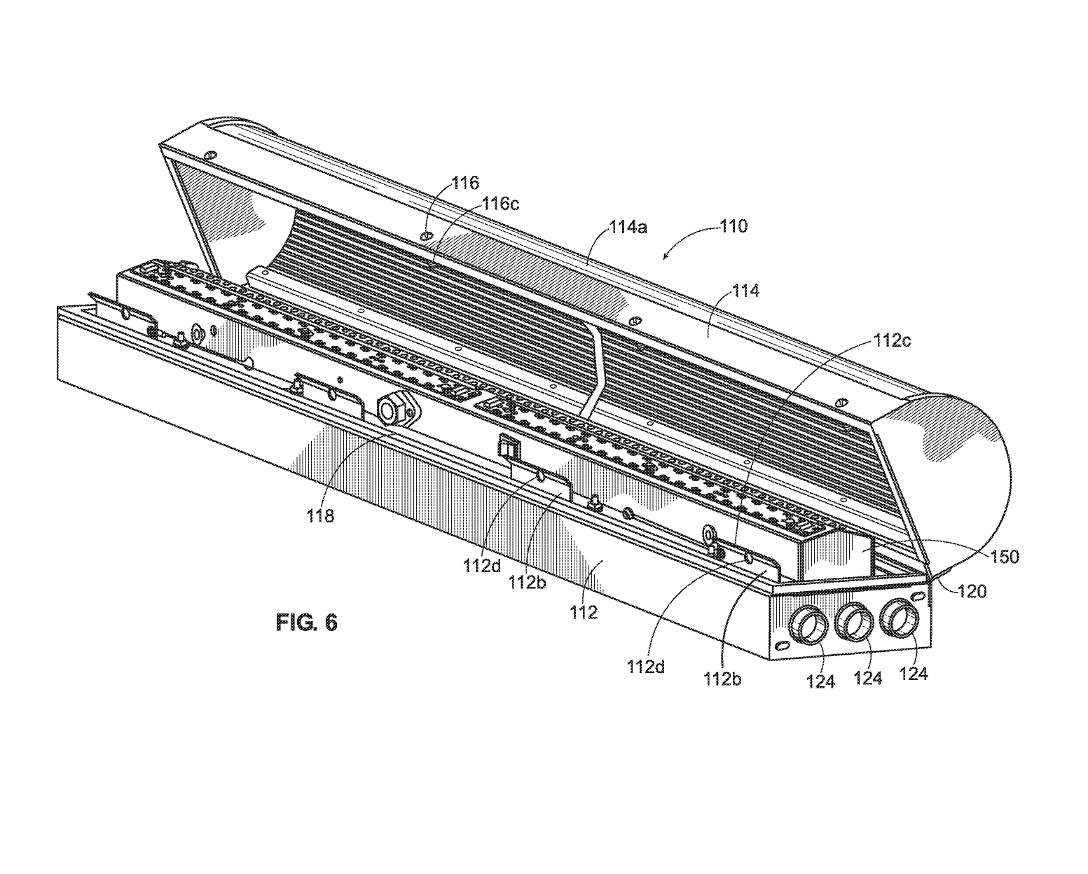

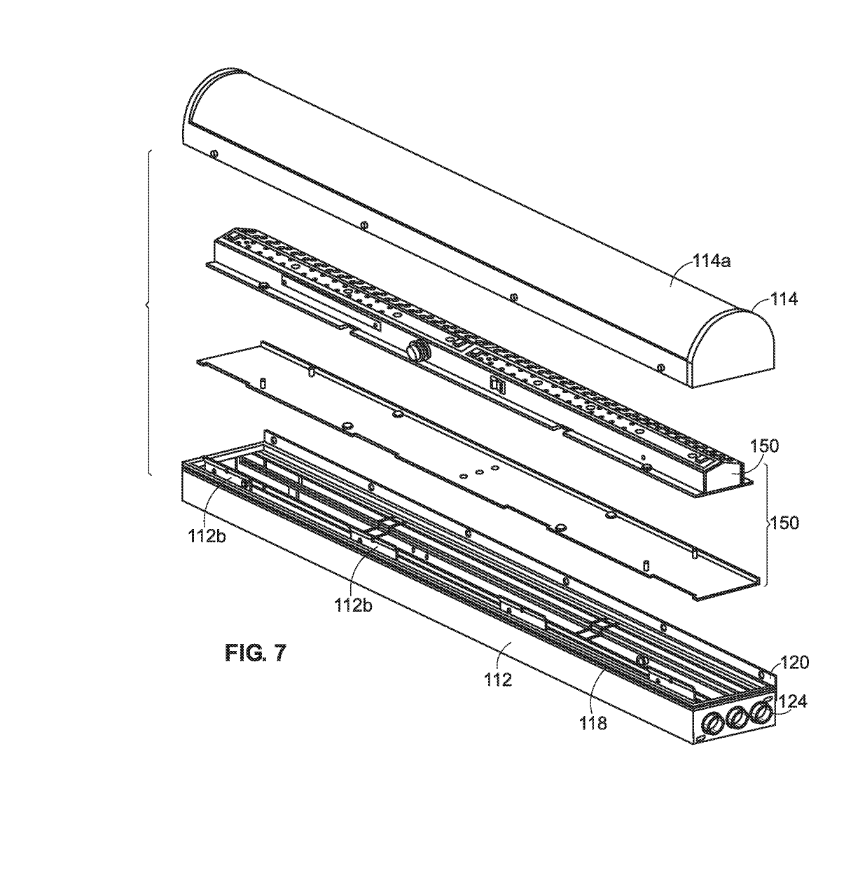

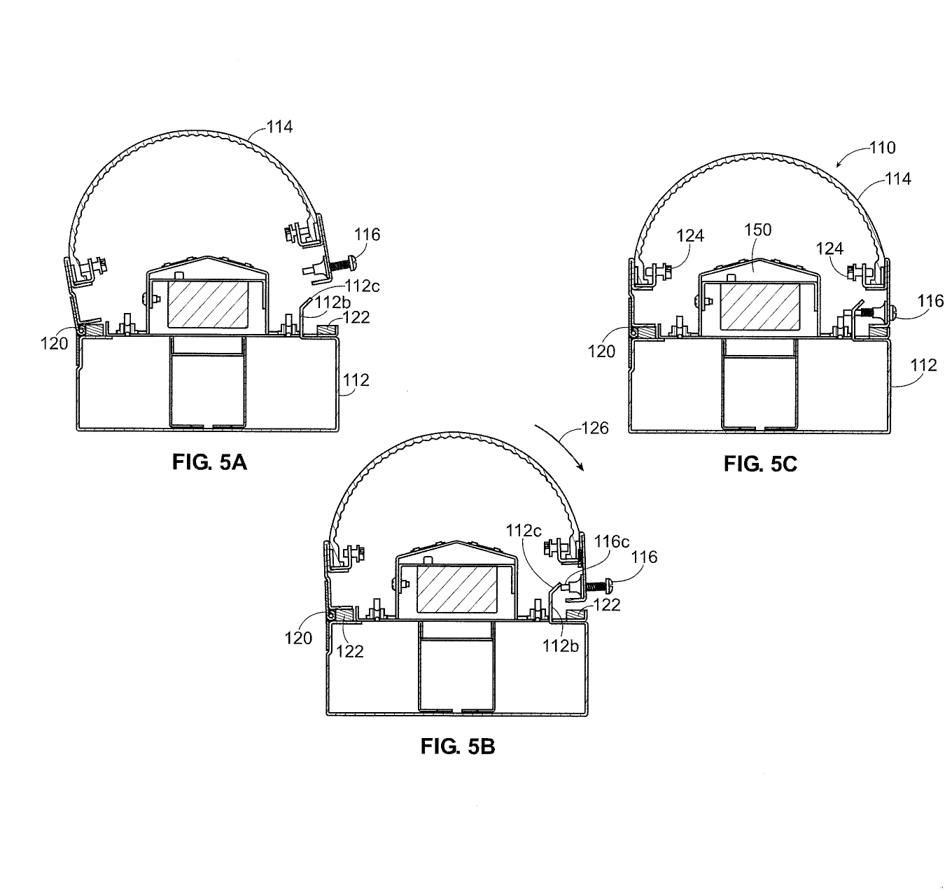

FIGS. 6 and 7 show a more complete housing fixture 110 and more clearly fleshes out the various elements shown in the other fixtures, including showing, in FIG. 7 an exploded view of the components of the light fixture. Like items are numbered as in the prior figures.

In the operation of the fixture housing, it will be understood that in the closing of the fixture 110, the diffuser 114 and base 112 are pushed together until nearly closed and such that fastener 116 becomes adjacent to and touching linear cam 112c. The user then pushes a screw driver, or other similar tool, into the head of fastener 116 and turns the fastener such that it enters further into diffuser 116 and with each turn causes the distal end 116c of fastener 116 to push against linear cam 112c causing the fastener to slide against linear cam 112c pulling the diffuser 114 onto the base 112 and sealing the diffuser and base together into an IP65 impermeability condition.

It will be understood that by this means, less user force is required to achieve the IP65 impermeability condition, as the linear cam and fastener act as a machine to mechanically increase the force provided by the user. In addition, as the force necessary to achieve the IP65 standard is now achievable from the side of the fixture rather than at an angle of 90° (as in the prior art), the depth of the fixture box can be decreased and made more narrow so that it now has a smaller profile and can be placed in more locations. The smaller profile further acts to diminish the size of the device such that it is no longer such a desirable target for vandals.

Although an illustrative embodiment of the invention has been shown and described, it is to be understood that various modifications and substitutions may be made by those skilled in the art without departing from the novel spirit and scope of the invention.

What is claimed is:

1. A light fixture housing having IP65 or better impermeability protection when closed, comprising:
a base, comprising a box, having a bottom and sides, and having space for a light fixture to be placed therein, the base being pivotally attached, by pivoting means, at one side to a lid having a lens thereon, the base having fastening means on a side opposite to the pivoting means, the fastening means comprising at least a fastener and a linear cam;
the base and lid being fastenably closed together such that the tightening of the fastener against the linear cam pivots the lid tightly against the base to create the IP65 impermeability.

2. The fixture housing of claim 1, wherein the fastener is a screw.

3. The fixture housing of claim 1, wherein the linear cam is joined to a flange having an opening in which the fastener is parked when fully tightened.

4. The fixture housing of claim 1, including a pliable gasket between the lid and base to perfect a seal when the base and lid are fastenably joined together.

5. The fixture housing of claim 2, wherein the fastening means includes a nut fixed to the lid for receiving the fastener therein.

6. The fixture housing of claim 1, wherein the linear cam is inclined at between 20° and 70° degrees.

7. The fixture housing of claim 1, wherein the linear cam is inclined at 45°.

8. The fixture housing of claim 1, wherein an LED light fixture is placed within.

9. The fixture housing of claim 1, wherein the pivoting means is a hinge.

10. A light fixture housing having IP65 or better impermeability protection when closed, comprising:
a base, comprising a box, having a bottom and sides, and having space for a light fixture to be placed therein, the base being pivotally attached, by a hinge, at one side to a lid having a diffuser thereon, the base having fastening means on a side opposite to the hinge, the fastening means comprising at least a screw and a linear cam;
the base and lid being fastenably closed together such that the screwing the fastener into the lid pushes the distal end of the screw against the linear cam causing the lid to pivot tightly against the base to create the IP65 impermeability.

11. The fixture housing of claim 10, wherein the linear cam is joined to a flange having an opening in which the distal end of the screw is locked when the screw is fully tightened into the lid.

12. The fixture housing of claim 10, including a pliable gasket between the lid and base to perfect a seal when the base and lid are fastenably joined together.

13. The fixture housing of claim 10, wherein the fastening means includes a nut fixed to the lid for receiving the screw therein.

14. The fixture housing of claim 10, wherein the linear cam is inclined at between 20° and 70° degrees.

15. The fixture housing of claim 10, wherein the linear cam is inclined at 45°.

16. The fixture housing of claim 10, wherein an LED light fixture is placed within.
